(19) United States
(12) Patent Application Publication
(10) Pub. No.: US 2006/0250259 A1
(43) Pub. Date: Nov. 9, 2006

(54) Monitoring device, care receiver monitoring device, care managing device, care giver terminal device, and care support system and care support method using these

(75) Inventor: Konami Izumi, Atsugi (JP)

Correspondence Address: ERIC ROBINSON, PMB 955, 21010 SOUTHBANK ST., POTOMAC FALLS, VA, 20165, US

(73) Assignee: Semiconductor Energy Laboratory Co., Ltd., Atsugi-shi (JP)

(21) Appl. No.: 11/370,829

(22) Filed: Mar. 9, 2006

(30) Foreign Application Priority Data
Mar. 25, 2005 (JP) 2005-089223

(51) Int. Cl. G08B 21/00

(52) U.S. Cl. 340/612

(57) ABSTRACT

A care receiver monitoring device includes a biological information detecting unit, a detection control unit, a detected information storing unit, a wireless communication unit, and a care receiver specific information storing unit. A monitoring device reader includes a wireless communication unit, a reader specific information storing unit, a wireless communication unit, and a line communication unit. A care managing device includes an information processing unit, a line communication unit, a terminal communication unit, and a care information storing unit. A care giver terminal device includes a communication unit and a display unit. A care giver terminal device further includes an alarm unit and an information requesting unit. Each of the care support system and the care support method uses a care receiver monitoring device, a monitoring device reader, a care managing device, and a care giver terminal device.

### BACKGROUND OF THE INVENTION

1. Field of the Invention

The invention relates to a care receiver monitoring device which includes a sensor to detect biological information of a care receiver. Moreover, the invention relates to a monitoring device reader to communicate wirelessly with the care receiver monitoring device. Further, the invention relates to a care managing device to determine a life status based on the biological information of the care receiver. Further, the invention relates to a care giver terminal device which displays a life status of the care receiver. Further, the invention relates to a care giver terminal device which displays a status of a care receiver. Further, the invention relates to a care support system and a care support method each of which is provided with a care receiver monitoring device, a monitoring device reader, a care managing device, and a care giver terminal device to support the care by detecting biological information of the care receiver and sending it to the care giver.

2. Description of the Related Art

In recent years, decline of birthrate and aging of population are rapidly progressing. In accordance with that, a load of care for the aged, sick and wounded is becoming a social problem. Hereafter, the aged, sick, wounded and the like who receive care are referred to as care receivers. To care, a great deal of time, money, and labor are required in many cases, which is often a problem for families, care givers and the like who care the care receiver. Hereafter, families, care givers, and the like are referred to as care givers.

In order to reduce such a load of care, technical development has been advanced to support the care by using a semiconductor device such as a sensor, a computer, and a portable terminal. For example, there is a system for detecting abnormality of a person in need of care (for example, see Patent Document 1) to monitor a person in need of care who exists in a room provided with an infrared sensor to detect a human, a device to process information from the sensor, an alarm device and the like. Further, there is a system provided with a monitoring camera, a device to process information from the camera, a portable terminal, and the like, for monitoring a person in need of care in a facility where many people in need of care live, and a method for monitoring a person in need of care (for example, see Patent Document 2).

[Patent Document 1]

Patent Document No. 3606386

[Patent Document 2]

Patent Document No. 2005-46320

### SUMMARY OF THE INVENTION

An abnormality of a care receiver can be quickly detected by monitoring the care receiver using the aforementioned technique at all times. With the infrared sensor and the monitoring camera which are provided indoors, however, it is difficult to provide a care support for the care receivers on a person-by-person basis. Moreover, in some cases, a care giver who provides care in a family demands for a care support system which provides information of the care receiver at low cost.

In view of this, the invention provides a care support system for care receivers on a person-by-person basis by detecting biological information of the care receivers at all times. Further, the invention provides a care support system which can reduce temporal, financial, and physical loads of care. Further, the invention provides a care support system which enables a physical abnormality of the care receiver to be found quickly. Further, the invention provides a care receiver monitoring device and a monitoring device reader which can be manufactured at low cost, a care managing device and a care giver terminal device which enable existing hardware resources to be efficiently used, a care support system which can be easily constructed and used at low cost, and a care support method.

A care receiver monitoring device of the invention includes a biological information detecting unit which detects biological information of the care receiver, a detection control unit which controls the biological information detecting unit, a detected information storing unit which stores the detected information, a wireless communication unit which communicates wirelessly with the monitoring device reader through electromagnetic waves, and a care receiver specific information storing unit which stores care receiver specific information.

It is to be noted that the biological information means, for example, a body temperature, a heart rate, a blood pressure, a breathing rate, an amount of blood gas (oxygen, carbon dioxide, carbon monoxide, and the like), and the like.

In the care receiver monitoring device of the invention, the biological information detecting unit includes a sensor for detecting biological information and the like. The detection control unit includes a power source device, a counter, a sensor control circuit, a memory control circuit, and the like. The detected information storing unit includes a memory and the like. The wireless communication unit includes a resonant circuit, a power source circuit, a demodulation circuit, a modulation circuit, an encoding circuit, a decoding circuit, an information determining circuit, a memory control circuit and the like. The care receiver specific information storing unit includes a memory and the like.

In the care receiver monitoring device of the invention, the power source device included in the detection control unit is a power generating device which generates power by light or a body temperature.

In the care receiver monitoring device of the invention, a memory included in the detected information storing unit is a nonvolatile memory in which data can be rewritten.

In the care receiver monitoring device of the invention, the memory included in the care receiver specific information storing unit is a write-once type nonvolatile memory. A write-once type nonvolatile memory is a nonvolatile memory in which data can be written only once and cannot be erased nor changed.

In the care receiver monitoring device of the invention, the sensor included in the biological information detecting unit is a sensor which detects a body temperature, a heart rate, a blood pressure, a breath rate, a blood oxygen rate, a moving rate of a care receiver's body, or an acceleration rate of a care receiver's body.

In the care receiver monitoring device of the invention, the care receiver specific information contains an identification number for identifying a care receiver.

The monitoring device reader of the invention includes a wireless communication control unit which controls the wireless communication unit, a reader specific information storing unit which stores reader specific information which specifies each reader, a wireless communication unit which communicates wirelessly with the care receiver monitoring device through electromagnetic waves, a line communication unit which communicates with the care managing device through a communication line.

In the monitoring device reader of the invention, the wireless communication control unit includes a counter, a control circuit, and the like. The reader specific information storing unit includes a memory and the like. The wireless communication unit includes a resonant circuit, a demodulation circuit, a modulation circuit, an encoding circuit, a decoding circuit, an information determining circuit, and the like. The line communication unit includes a communication control circuit, a memory control circuit, and the like.

The monitoring device reader includes a reception reader and a transmission reader. The reception reader includes a wireless communication control unit which controls the wireless communication unit, the wireless communication unit which communicates wirelessly with the care receiver monitoring device through electromagnetic waves, and a first communication unit between the readers, which communicates wirelessly with the transmission reader. The transmission reader includes the reader specific information storing unit which stores reader specific information, the line communication unit which communicates with the care managing device through a communication line, and a second communication unit between the readers, which communicates wirelessly with the reception reader.

In the monitoring device reader of the invention, the wireless communication control unit includes a counter, a control circuit, and the like. The reader specific information storing unit includes a memory and the like. The wireless communication unit includes a resonant circuit, a demodulation circuit, a modulation circuit, an encoding circuit, a decoding circuit, an information determining circuit, and the like. The line communication unit includes a communication control circuit, a memory control circuit, and the like. Each of the first communication unit between the readers and the second communication unit between the readers includes a resonant circuit, a demodulation circuit, a modulation circuit, an encoding circuit, a decoding circuit, an information determining circuit, a power source device, and the like.

Further, the monitoring device reader of the invention is provided with a communication cutting off unit for temporarily cutting off wireless communication with the care receiver monitoring device.

In the monitoring device reader of the invention, the communication cutting off unit includes an input device, a communication cutting off signal generating circuit, and the like.

Further, the monitoring device reader of the invention is provided with a communication resuming unit for resuming the wireless communication with the care receiver monitoring device, which is interrupted by the communication cutting off unit.

In the monitoring device reader of the invention, the communication resuming unit includes an input device, a communication resuming signal generating circuit, and the like.

The care managing device of the invention includes an information processing unit which determines a life status of a care receiver based on the detected information, the care receiver specific information, the reader specific information, and the care information. In addition, the care managing device of the invention includes the line communication unit which communicates with the monitoring device reader through a communication line, a terminal communication unit which communicates with a care giver terminal device, and the care information storing unit which stores the care information.

It is to be noted that the life status means a general condition of a care receiver 201 whose function of body is decreased due to the age, sickness, wound, and the like. For example, various conditions of a care receiver such as a death, a critical condition, and a health condition are included.

In the care managing device of the invention, the information processing unit includes an SRAM (Static Random Access Memory), a central processing unit (CPU), a memory control circuit, and the like. The line communication unit includes a communication control circuit, and the like. The terminal communication unit includes a communication control circuit, a memory control circuit, an antenna, a demodulation circuit, a modulation circuit, and the like. The care information storing unit includes a hard disc and the like.

The care managing device includes a computer and a database which are connected through a network. The computer includes an information processing unit which determines a life status of a care receiver based on the detected information, the care receiver specific information, the reader specific information, and the care information. In addition, the care managing device of the invention includes the line communication unit which communicates with the monitoring device reader through a communication line, and a terminal communication unit which communicates with a care giver terminal device. The database includes a care information storing unit which stores care information.

In the care managing device of the invention, the information processing unit includes an SRAM (Static Random Access Memory), a central processing unit (CPU), a memory control circuit, and the like. The line communication unit includes a communication control circuit, and the like. The terminal communication unit includes a communication control circuit, a memory control circuit, an antenna, a demodulation circuit, a modulation circuit, and the like. The care information storing unit includes a hard disc and the like.

In the care managing device of the invention, the care information storing unit databases and stores the care information related to a care support and reads out the care information corresponding to the care receiver specific information stored in the care receiver monitoring device.

The care giver terminal device of the invention includes a communication unit which communicates with a care managing device and a display unit which displays biological information, a life status, and the like of the care receiver.

In the care giver terminal device of the invention, the communication unit includes a communication control circuit, an antenna, a demodulation circuit, a modulation circuit, and the like. The display unit includes a memory, a memory control circuit, a display device, and the like.

Further, the care giver terminal device is provided with an alarm unit which beeps when information is received.

In the care giver terminal device of the invention, the alarm unit includes a speaker, and the like.

Further, the care giver terminal device is provided with an information requesting unit which requests the information of the care receiver from the care managing device.

In the care giver terminal device of the invention, the information requesting unit includes an input device, an instruction signal generating circuit, and the like.

The care support system of the invention includes a care receiver monitoring device which detects biological information of the care receiver and sends it to the monitoring device reader, the monitoring device reader which sends the information received from the care receiver monitoring device to the care managing device, a care managing device which determines a life status of the care receiver based on the information received from the monitoring device reader and sends it to the care giver terminal device, and the care giver terminal device which displays the information received from the care managing device.

A care support method of the invention includes a step that the care receiver monitoring device detects biological information of the care receiver and sends it to the monitoring device reader, a step that the monitoring device reader sends the information received from the care receiver monitoring device to the care managing device, a step that the care managing device determines a life status of the care receiver based on the information received from the monitoring device reader and sends it to the care giver terminal device, and a step that the care giver terminal device displays the information received from the care managing device.

A care support method of the invention further includes a step that the care giver terminal device sends an information requesting instruction to the care managing device, a step that the care managing device receives the instruction and sends the information requesting instruction to the monitoring device reader, and a step that the monitoring device reader receives the instruction and sends the information requesting instruction to the care receiver monitoring device.

With a care support system of the invention with the aforementioned structure, a physical abnormality of the care receiver can be found quickly by detecting biological information of the care receiver at all times or at an appropriate time interval, and a care support for the care receivers can be provided on a person-by-person basis. Further, the care receiver monitoring device and the monitoring device reader of the invention can be manufactured at low cost and the care managing device and the care giver terminal device of the invention can efficiently use existing hardware resources. Therefore, the care support system of the invention can be easily constructed and used at low cost. Consequently, the invention can reduce temporal, financial, and physical loads on the care givers.

### BRIEF DESCRIPTION OF DRAWINGS

FIG. 1 is a diagram showing a structure of a care support system of the invention.

FIG. 2 is a diagram showing a mode to use a care support system of the invention.

FIGS. 3A to 3D are views of modes to attach a care receiver monitoring device of the invention.

FIGS. 4A to 4D are views of modes to provide a monitoring device reader of the invention.

FIG. 5 is a diagram showing a structure of a care managing device of the invention as an example.

FIGS. 6A and 6B are diagrams showing care information stored in a care managing device of the invention.

FIG. 7 is a diagram showing an operation to request for information in a care support system of the invention.

FIGS. 8A to 8D are views of examples of a care giver terminal devices of the invention.

### DETAILED DESCRIPTION OF THE INVENTION

Although the invention will be fully described by way of embodiment modes and embodiments with reference to the accompanying drawings, it is to be understood that various changes and modifications will be apparent to those skilled in the art. Therefore, unless such changes and modifications depart from the scope of the invention, they should be construed as being included therein. Note that identical portions in embodiment modes and embodiments are denoted by the same reference numerals.

### Embodiment Mode 1

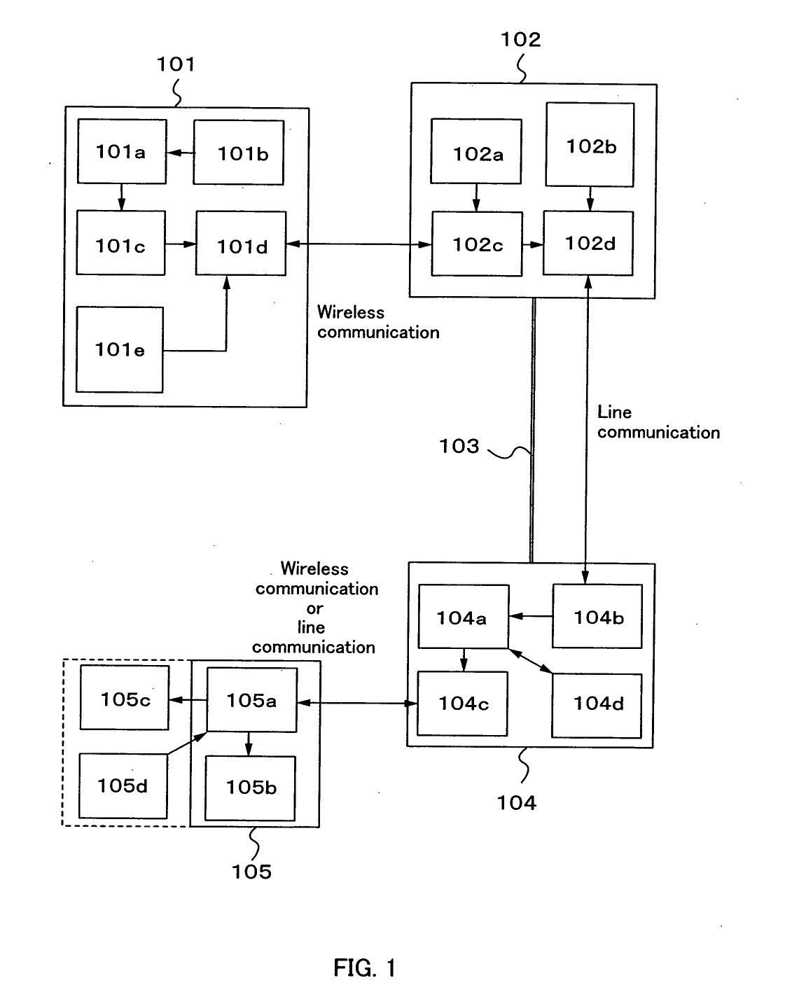

As shown in FIG. 1, a care support system of the invention is constructed of a care receiver monitoring device 101, a monitoring device reader 102, a care managing device 104, and a care giver terminal device 105. The monitoring device reader 102 is connected to the care managing device 104 through a communication line 103.

In the care support system of the invention with the aforementioned structure, the care receiver monitoring device 101 detects biological information of the care receiver and sends the detected biological information to the monitoring device reader 102. The monitoring device reader 102 sends the information received from the care receiver monitoring device 101 to the care managing device 104. The care managing device 104 determines a life status of a care receiver based on the received information and sends the determined information related to the life status to the care giver terminal device 105. The care giver terminal device 105 displays the received information.

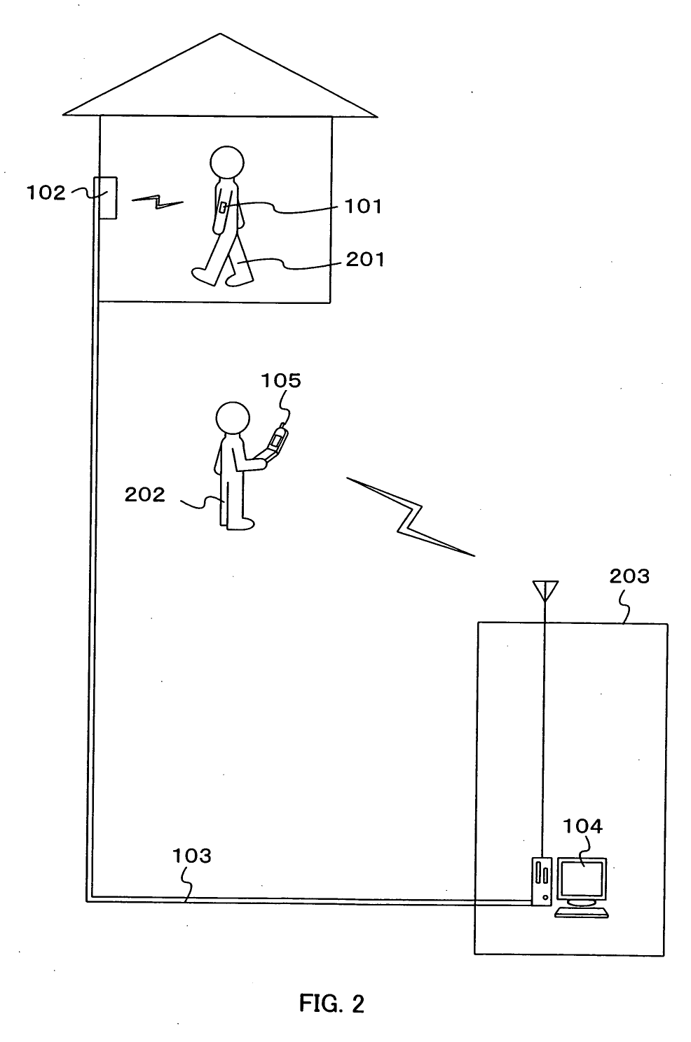

FIG. 2 shows a mode to use the care support system with the aforementioned structure. The care support system of the invention is provided for a care receiver 201 and families, care givers and the like who care the care receiver to support the care. Hereafter, the families, care givers, and the like who care the care receiver are collectively referred to as a care giver 202.

The care receiver monitoring device 101 which is attached to around a surface of a body or implanted in a body of the care receiver 201 detects biological information of the care receiver 201 and sends the detected biological information to the monitoring device reader 102. The monitoring device reader 102 is provided in a living area of the care receiver who puts on the care receiver monitoring device 101 and sends the information received from the care receiver monitoring device 101 to the care managing device 104. The care managing device 104 is provided in an office 203 and the like of an organization which provides a care support system and determines a life status of the care receiver 201 based on the information received from the monitoring device reader 102 and sends it to the care giver terminal device 105. The care giver 202 carries the care giver terminal device 105 which displays the information received from the care managing device 104. The care giver 202 can check a life status, biological information, and the like of the care receiver 201 in charge by seeing the information displayed by the care giver terminal device 105, which contributes to the care.

Next, description is made on the care receiver monitoring device 101, the monitoring device reader 102, the care managing device 104, and the care giver terminal device 105 which form the care support system of the invention.

The care receiver monitoring device 101 of the invention is manufactured by using an RFID (Radio Frequency Identification) technology which communicates wirelessly through electromagnetic waves and a sensor technology to detect biological information.

The care receiver monitoring device 101 detects biological information of the care receiver 201 at all times or at an appropriate time interval and stores the detected information such as the biological information and the detection time per detection. When the care receiver monitoring device 101 receives an information requesting instruction from the monitoring device reader 102, it sends the detected information and the care receiver specific information stored therein to the monitoring device reader 102. As shown in FIG. 1, the care receiver monitoring device 101 with the aforementioned function includes a biological information detecting unit 101a, a detection control unit 101b, a detected information storing unit 101c, a wireless communication unit 101d, and a care receiver specific information storing unit 101e.

The biological information detecting unit 101a detects biological information of the care receiver 201 at all times or at an appropriate time interval in accordance with a control from the detection control unit 101b. Accordingly, the biological information detecting unit 101a includes a sensor and the like to detect the biological information.

The detection control unit 101b controls the biological information detecting unit 101a to detect biological information of the care receiver 201 at all times or at an appropriate time intervel. Therefore, the detection control unit 101b includes a power source device, a counter, a sensor control circuit, a memory control circuit, and the like. Here, the power source device is a power generating device and the like which generate power by light, a temperature or the like as well as a battery.

The detected information storing unit 101c stores the information per detection such as the biological information and the detection time detected by the biological information detecting unit 101a. Accordingly, the detected information storing unit 101c includes a memory, and preferably a rewritable nonvolatile memory.

The wireless communication unit 101d receives an information requesting instruction from the monitoring device reader 102 wirelessly through electromagnetic waves at a specific frequency and sends the detected information and the care receiver specific information to the monitoring device reader 102. Accordingly, the wireless communication unit 101d includes a resonant circuit, a power source circuit, a demodulation circuit, a modulation circuit, an encoding circuit, a decoding circuit, an information determining circuit, a memory control circuit, and the like.

The care receiver specific information storing unit 101e stores care receiver specific information containing an identification number for identifying one of the care receiver 201 among a plurality of the care receivers 201. Accordingly, the care receiver specific information storing unit 101e includes a memory, and more preferably a write-once type nonvolatile memory. A write-once type nonvolatile memory is a nonvolatile memory in which data can be written only once and cannot be erased nor changed.

The monitoring device reader 102 of the invention sends an information requesting instruction wirelessly to the care receiver monitoring device 101 through electromagnetic waves at a specific frequency and receives biological information and care receiver specific information sent from the care receiver monitoring device 101 in accordance with the instruction. Then, the monitoring device reader 102 sends the received information and the stored reader specific information to the care managing device 104 through the communication line 103. As shown in FIG. 1, the monitoring device reader 102 having the aforementioned function includes a wireless communication control unit 102a, a reader specific information storing unit 102b, a wireless communication unit 102c, and a line communication unit 102d.

The wireless communication control unit 102a controls the wireless communication unit 102c to communicate with the care receiver monitoring device 101 at all times or at an appropriate time interval. Accordingly, the wireless communication control unit 102a includes a counter, a control circuit, and the like.

The reader specific information storing unit 102b identifies each monitoring device reader 102 among a plurality of the monitoring device readers 102 provided in a living area of the care receiver 201 and stores reader specific information to specify the location thereof and the like. Accordingly, the reader specific information storing unit 102b includes a memory.

The wireless communication unit 102c sends an information requesting instruction wirelessly to the care receiver monitoring device 101 through electromagnetic waves at a specific frequency at all times or at an appropriate time interval. Then, the wireless communication unit 102c receives the detected information and the care receiver specific information sent from the care receiver monitoring device 101 and sends the received data to the line communication unit 102d. Accordingly, the wireless communication unit 102c includes a resonant circuit, a demodulation circuit, a modulation circuit, an encoding circuit, a decoding circuit, an information determining circuit, and the like.

The line communication unit 102d sends the detected information, the care receiver specific information, and the reader specific information sent from the wireless communication unit 102c to the care managing device 104 through the communication line 103. Accordingly, the line communication unit 102d includes a communication control circuit, a memory control circuit, a data transmission path and the like. The data transmission path is used for sending data by parallel transmission or serial transmission, such as a data bus.

The care managing device 104 of the invention receives the detected information, the care receiver specific information, and the reader specific information sent from the monitoring device reader 102, determines a life status of the care receiver 201 based on the received information and the stored care information, and sends the information such as the biological information and the life status of the care receiver 201 to the care giver terminal device 105. As shown in FIG. 1, the care managing device 104 having the aforementioned function includes an information processing unit 104a, a line communication unit 104b, a terminal communication unit 104c, and a care information storing unit 104d.

Receiving the detected information, the care receiver specific information, and the reader specific information from the line communication unit 104b, the information processing unit 104a reads out required care information from the care information storing unit 104d in accordance with an information processing program file. Then, the information processing unit 104a determines a life status based on a difference between the biological information and a standard value of the biological information, a change with time of the biological information, a position of the monitoring device reader 102 which communicates with the care receiver monitoring device 101, identification information of the care receiver 201 and the like, and sends the information such as the biological information and the life status to the terminal communication unit 102e. Accordingly, the information processing unit 104a includes an SRAM (Static Random Access Memory), a central processing unit (CPU), a memory control circuit, and the like. Here, the information processing program file is stored in the care information storing unit 104d and used for determining a life status of a care receiver based on the detected information and the like of the care receiver, the care information, and the like.

The line communication unit 104b receives the detected information, care receiver specific information and reader specific information sent from the monitoring device reader 102 through the communication line 103 and sends them to the information processing unit 104a. Accordingly, the line communication unit 104b includes a communication control circuit, a data transmission path, and the like.

The terminal communication unit 104c sends to the care giver terminal device 105 information such as the biological information and the life status of the care receiver 201 sent from the information processing unit 104a. Accordingly, the terminal communication unit 104c includes a communication control circuit, a memory control circuit, an antenna, a demodulation circuit, a modulation circuit, a data transmission path, and the like.

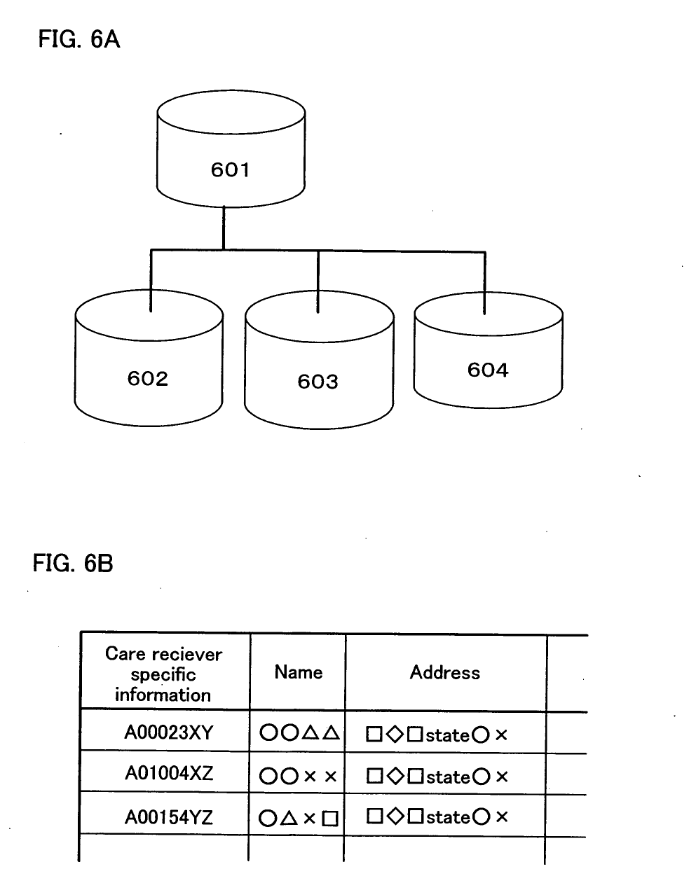

As shown in FIG. 6A, the care information storing unit 104d databases and stores an information processing program file 601 and various care information related to a care support, such as personal information of a care receiver and a standard value of biological information. Accordingly, the care information storing unit 104d includes a hard disc.

As shown in FIG. 6A, the care information stored in the care information storing unit 104d includes a care receiver personal information database 602 which stores personal information of a care receiver, a care receiver biological information database 603 which stores biological information of a care receiver, a terminal information database 604 which stores information related to the care giver terminal device 105 which sends the processed information, and the like.

For example, the care receiver personal information database 602 stores the name, address, birth date, contact address of the care receiver, height, weight, past history, kind of biological information to be detected, sickness suffered, and the like. The care receiver personal information is registered at first when starting the care support system, and uploaded whenever necessary. The care receiver biological information database 603 stores the detected information such as an average value of the biological information of the care receiver and biological information which have been detected since the care support system was started to be used. The terminal information database 604 stores information related to the care giver terminal device 105 which sends the information processed by the information processing unit 104a, such as a phone number and an e-mail address which are required for sending the processed information. Then, the care information is read out and written by the information processing program file 601.

In order to improve the security of the information, the care receiver specific information stored in the care receiver monitoring device 101 is required for reading out the information by accessing the each database. Therefore, the care information stored in the care information storing unit 104d can be stored per care receiver specific information. FIG. 6B shows a mode that the care receiver personal information database 602 stores personal information of a care receiver The care receiver specific information is used for specifying a care receiver and differs from one care receiver to another. For example, the care receiver specific information contains identification numbers such as “A00023XY”, “A01004XZ”, and “A00154YZ”, for example. The care receiver personal information is stored per care receiver specific information and read out using the care receiver specific information.

Next, the care giver terminal device 105 receives the information such as the biological information and the life status of the care receiver 201 sent from the care managing device 104 and displays the received information. As shown in FIG. 1, the care giver terminal device 105 having the aforementioned function includes a communication unit 105a and a display unit 105b. Further, the care giver terminal device 105 includes an alarm unit 105c. Moreover, the care giver terminal device 105 includes an information requesting unit 105d.

The communication unit 105a receives the information such as the biological information and the life status of the care receiver 201 sent from the care managing device 104 and sends the received information to the display unit 105b. Accordingly, the communication unit 105a includes a communication control circuit, an antenna, a demodulation circuit, a modulation circuit, a data transmission path, and the like.

The display unit 105b displays the information such as the biological information and the life status of the care receiver 201 sent from the communication unit 105a. Accordingly, the display unit 105b includes a memory, a memory control circuit, a display device, and the like.

The care giver terminal device 105 is further provided with an alarm unit 105c which beeps when receiving information from the care managing device 104. The alarm unit 105c includes a speaker, and the like.

The care giver terminal device 105 further includes an information requesting unit 105d which requests the care managing device 104 to send the information such as the biological information and the life status of the care receiver 201. The information requesting unit 105d includes an input device, an instruction signal generating circuit, and the like.

The care support system of the invention constructed of the care receiver monitoring device 101, the monitoring device reader 102, the care managing device 104, and the care terminal device 105 which have the aforementioned structure has a following function. That is, the care receiver monitoring device 101 detects the biological information of the care receiver 201 at all times or at an appropriate time interval and stores the detected information per detection such as the biological information and the detection time. Receiving an information requesting instruction from the monitoring device reader 102, the care receiver monitoring device 101 sends the detected information and the care receiver specific information stored therein to the monitoring device reader 102.

The monitoring device reader 102 sends an information requesting instruction wirelessly to the care receiver monitoring device 101 through electromagnetic waves at a specific frequency, receives the biological information and the care receiver specific information sent from the care receiver monitoring device 101 in accordance with the instruction, and sends the received information and the stored reader specific information to the care managing device 104 through the communication line 103.

The care managing device 104 receives the detected information, the care receiver specific information, and the reader specific information sent from the monitoring device reader 102, determines a life status of the care receiver 201 based on the received information and the stored care information, and sends the information such as the biological information and the life status of the care receiver 201 to the care giver terminal device 105.

The care giver terminal device 105 receives the information such as the biological information and the life status of the care receiver 201 sent from the care managing device 104 and displays the received information.

Further, the care giver terminal device 105 includes the alarm unit 105c which beeps when receiving information from the care managing device 104. The care giver terminal device 105 further includes the information requesting unit 105d which requests the care managing device 104 to send the information such as the biological information and the life status of the care receiver 201.

According to a care support method of the invention using the care receiver monitoring device 101, the monitoring device reader 102, the care managing device 104, and the care giver terminal device 105 which have the aforementioned structures, the biological information detecting unit 101a included in the care receiver monitoring device 101 detects the biological information of the care receiver 201 at all times or at an appropriate time interval in accordance with a control from the detection control unit 101b. Next, the detected information storing unit 101c included in the care receiver monitoring device 101 stores the information per detection detected by the biological information detecting unit 101a, such as the biological information and the detection time. Next, a wireless communication unit 102c included in the monitoring device reader 102 sends an information requesting instruction wirelessly to the care receiver monitoring device 101 through electromagnetic waves at a specific frequency at all times or at an appropriate time interval in accordance with a control from the wireless communication control unit 102a.

Next, receiving the information requesting instruction from the monitoring device reader 102, the wireless communication unit 101d included in the care receiver monitoring device 101 sends the detected information and the care receiver specific information to the monitoring device reader 102. Subsequently, the wireless communication unit 102c included in the monitoring device reader 102 receives the detected information and the care receiver specific information sent from the care receiver monitoring device 101 in accordance with the instruction and sends the received information to the line communication unit 102d. Then, the line communication unit 102d included in the monitoring device reader 102 sends to the care managing device 104 through the communication line 103, the detected information, the care receiver specific information, and the reader specific information sent from the wireless communication unit 102c.

Next, the line communication unit 104b included in the care managing device 104 receives the detected information, the care receiver specific information, and the reader specific information sent from the monitoring device reader 102 through the communication line 103 and sends them to the information processing unit 104a. Next, receiving the detected information, the care receiver specific information, and the reader specific information from the line communication unit 104b, the information processing unit 104a included in the care managing device 104 reads out required care information from the care information storing unit 104d in accordance with the information processing program file, determines a life status based on a difference between the biological information and a standard value of the biological information, a change with time of the biological information, a position of the monitoring device reader 102 which communicates with the care receiver monitoring device 101, identification information of the care receiver 201 and the like, and sends the information such as the biological information and the life status to the terminal communication unit 102e. Then, the terminal communication unit 104c included in the care managing device 104 sends to the care giver terminal device 105 the information such as the biological information and the life status of the care receiver 201 sent from the information processing unit 104a.

Next, the communication unit 105a included in the care giver terminal device 105 receives the information such as the biological information and the life status of the care receiver 201 sent from the care managing device 104 and send the received information to the display unit 105b. Next, the display unit 105b included in the care giver terminal device 105 displays the information such as the biological information and the life status of the care receiver 201 sent from the communication unit 105a.

The alarm unit 105c included in the care giver terminal device 105 beeps when the care giver terminal device 105 receives information from the care managing device 104. Further, the information requesting unit 105d included in the care giver terminal device 105 requests the care managing device 104 to send the information such as the biological information and the life status of the care receiver 201.

With a care support system of the invention with the aforementioned structure, a physical abnormality of the care receiver can be found quickly by detecting biological information of the care receiver at all times or at an appropriate time interval, and a care support for the care receivers can be provided on a person-by-person basis. Further, the care receiver monitoring device of the invention can be manufactured at low cost and the care managing device and the care giver terminal device of the invention can efficiently use existing hardware resources. Therefore, the care support system of the invention can be easily constructed and used at low cost. Consequently, the invention can reduce temporal, financial, and physical loads on the care givers.

### Embodiment Mode 2

In this embodiment mode, description is made on a specific structure and a mode of the care receiver monitoring device 101 and the monitoring device reader 102 described in Embodiment Mode 1.

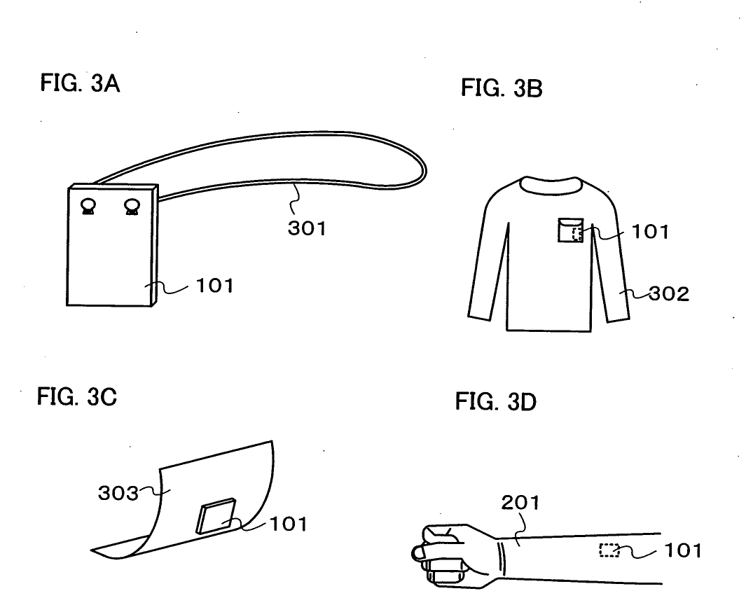

The care receiver monitoring device 101 of the invention is attached to around a surface of a body or implanted in a body of the care receiver 201. FIGS. 3A to 3D show modes that the care receiver 201 who uses the care support system puts on the care receiver monitoring device 101.

As shown in FIGS. 3A and 3B, the care receiver monitoring device 101 of the invention can be manufactured into a shape which is easy to carry, for example, into a card type and the like. As shown in FIG. 3A, the care receiver 201 can put the care receiver monitoring device 101 on a string 301 and wear it around the neck. As shown in FIG. 3B, the care receiver 201 can put the care receiver monitoring device 101 in a pocket of clothes 302. Further, as shown in FIGS. 3C and 3D, the care receiver monitoring device 101 can be manufactured in a small size, for example, about 5 mm square in size. As shown in FIG. 3C, the care receiver 201 can adhere the care receiver monitoring device 101 to his/her body by an adhesive tape 303. As shown in FIG. 3D, the care receiver monitoring device 101 can be implanted in a body of the care receiver 201.

A method that the care receiver 201 puts on the care receiver monitoring device 101 is not limited to the aforementioned examples. However, a method which may disturb the life of the care receiver 201 is undesirable. For example, the care receiver 201 who shows symptoms of senile dementia is likely to pluck off a foreign body which is within eye's and arm's reach. Accordingly, it is desirable that the care receiver 201 can put on the care receiver monitoring device 101 without conscious effort.

The care receiver monitoring device 101 of the invention detects the biological information of the care receiver 201 at all times or at an appropriate time interval. Accordingly, the care receiver monitoring device 101 includes a sensor to detect the biological information of the care receiver 201, such as a body temperature, a heart rate, a blood pressure, a breathing rate and an amount of blood gas (oxygen, carbon dioxide, carbon monoxide, and the like).

As shown in FIG. 3D, in the case of implanting the care receiver monitoring device 101 in a body of the care receiver 201, a sensor to detect biological information such as the amounts of blood sugar (glucose and the like), blood enzyme (γ-GTP, GOT, GPT, CPK (creatine kinase), LDH (Lactate Dehydrogenase enzyme), CHE (cholinesterase and the like), protein in the blood (total protein, albumin, globulin, and the like), uric acid in the blood (utera nitrogen, creatinine, uric acid, and the like), inorganic salt in the blood (Na, K, Cl, Ca, inorganic phosphate, Mg, serum iron, and the like), blood plasma, hormone in the blood (thyroid hormone, adrenal hormone, and the like), blood fat, (neutral fat, total cholesterol, HDL cholesterol, LDL cholesterol, triglyceride, phospholipids, and the like), blood count, blood cell count (a white blood cell, a red blood cell, a hematocrit, a blood platelet, hemoglobin, and the like), and the like. For example, in the case where a care receiver suffers from some disease, these biological information can be used for the health care.

The care receiver 201 can also be monitored by providing the care receiver monitoring device 101 with a sensor to detect a moving rate or an acceleration rate of the body of the care receiver 201. For example, when the care receiver monitoring device 101 includes a sensor to detect a moving rate and an acceleration rate in X, Y, and Z directions, the sensor can detect that the care receiver 201 fell down or got hit hard by something. In specific, the sensor including a power source device detects that the care receiver fell down and sends the information to the monitoring device reader 102.

The care receiver monitoring device 101 detects biological information typified by a body temperature and the like at all times or at an appropriate time interval. However, detected information of the moving rate and the acceleration rate of the care receiver 201 can be stored only when there is a change. This is because time to carry out detection and time that the moving rate changes may not match in the case where the biological information is detected at an appropriate time interval.

Further, the time interval to detect the biological information of the care receiver 201 can be appropriately set. That is, the detection can be carried out at a regular time interval or at a time interval corresponding to a behavioral pattern of the care receiver 201. For example, the detection of the biological information can be carried out at a narrower time interval when the care receiver 201 is awake while the detection of the same can be carried out at a wider time interval when the care receiver 201 is asleep.

As described above, a method that the care receiver 201 puts on the device, a kind of biological information to be detected, a time interval to detect the biological information, and the like of the care receiver monitoring device 101 of the invention can be set as required. With such care receiver monitoring device 101 and a care support system using this, a care support for the care receiver 201 and the care giver 202 can be provided on a person-by-person basis.

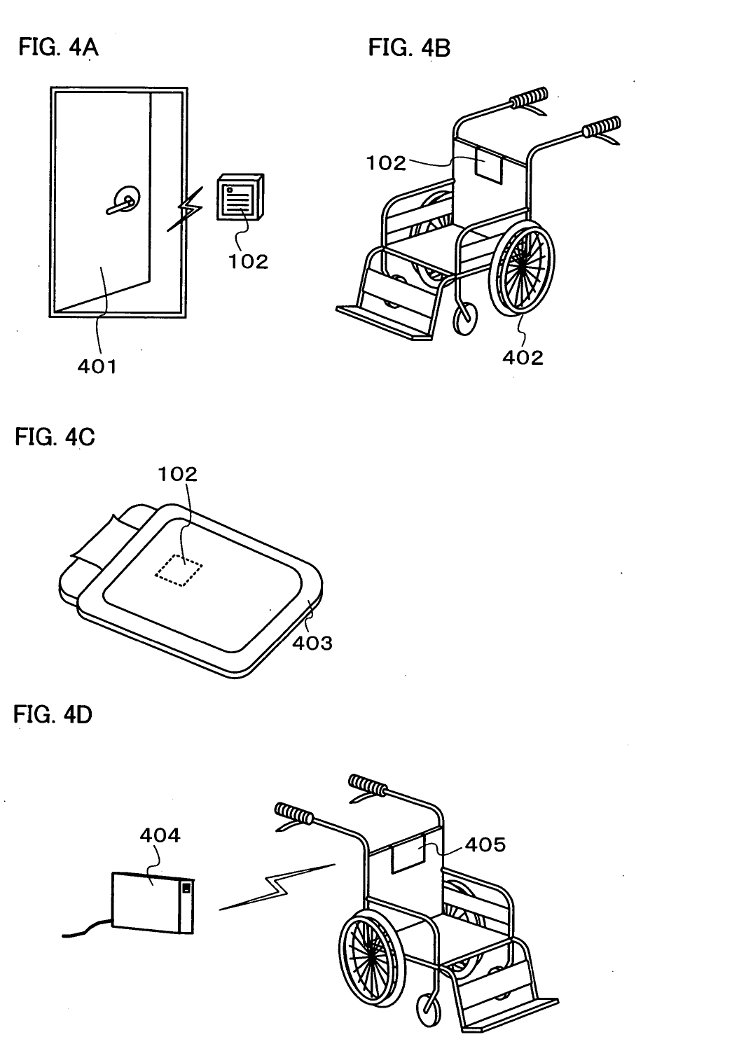

Next, description is made on the monitoring device reader 102 of the invention. The monitoring device reader 102 is provided in a living area of the care receiver 201 who puts on the care receiver monitoring device 101. FIGS. 4A to 4C show modes to provide the monitoring device reader 102 in using a care support system.

As shown in FIG. 4A, the monitoring device reader 102 is formed into a shape which is easy to be placed in any locations, such as a box shape or a cylindrical shape. Then, the monitoring device reader 102 is placed in a housing where the care receiver 201 lives, such as on a wall 401, a ceiling, and the like. As shown in FIGS. 4B and 4C, the monitoring device reader 102 can be formed into a shape which is easy to be placed in a living area of the care receiver 201, for example, a thin sheet form. For example, in the case where the care receiver 201 who puts on the care receiver monitoring device 101 lives on a wheelchair 402, the monitoring device reader 102 in a sheet form can be attached to a back of the wheelchair 402 as shown in FIG. 4B. Further, in the case where the care receiver 201 is confined to bed, the monitoring device reader 102 can be provided near a bedclothes 403 as shown in FIG. 4C.

One or a plurality of the monitoring device readers 102 is provided in a living area of the care receiver 201 in consideration of a communication distance with the care receiver monitoring device 101. A mode to place the monitoring device reader 102 is not limited to the aforementioned examples. However, a method which may disturb the life of the care receiver 201 and the care giver 202 is undesirable. For example, a plurality of the monitoring device readers 102 can be placed so that the care receiver monitoring device 101 which the care receiver 201 puts on is always within a communicable range of the monitoring device reader 102. Further, in the case where the monitoring device reader 102 is attached to the wheelchair 402 as shown in FIG. 4B, a structure where a power source line, a communication line, and the like are not required to be connected by providing a power source device and a wireless communication device.

Further, as shown in FIG. 4D, the monitoring device reader 102 may be formed by separating functions into a reception reader 405 and a transmission reader 404. For example, the reception reader 405 wirelessly receives information from the care receiver monitoring device 101 and wirelessly sends the received information to the transmission reader 404. The transmission reader 404 receives information from the reception reader and sends the received information to the care managing device 104. The structure of the monitoring device reader 102 is not limited to the aforementioned example, however, it is preferable to employ a structure which does not disturb the life of the care receiver 201 and the care giver 202 in this manner.

Next, description is made on the care receiver monitoring device 101 and the monitoring device reader 102. The care receiver monitoring device 101 wirelessly communicates with the monitoring device reader 102. A structure of the care receiver monitoring device 101 is categorized into an active type which has a power source device for communication and a passive type which receives power supply from the monitoring device reader 102 without a power source device.

The active type care receiver monitoring device 101 having a power source for communication can communicate over a long distance with the monitoring device reader 102. Therefore, in the case where a living area of the care receiver 201 is large, the active type care receiver monitoring device 101 can be used. Further, the passive type care receiver monitoring device 101 having no power source device for communication communicates over a shorter distance with the monitoring device reader 102 as compared to the active type, however, it can be compact, lightweight, and manufactured at low cost. Accordingly, in the case where a living area of the care receiver 201 is small, for example, the care receiver 201 is confied to live on a wheelchair or to bed, the passive type care receiver monitoring device 101 can be used.

The monitoring device reader 102 tries to communicate with the care receiver monitoring device 101 at all times or at an appropriate time interval. In the case where the care receiver monitoring device 101 and the monitoring device reader 102 communicate over a short distance, communication may be carried out only when the care receiver monitoring device 101 is within a communicable range of the monitoring device reader 102.

A care support system may have a structure where an abnormality of the care receiver 201 is determined based on a communication state between the care receiver monitoring device 101 and the monitoring device reader 102 even when there is no abnormality in the detected information of the care receiver 201. For example, in the case where all the monitoring device readers 102 placed in the living area of the care receiver 201 cannot communicate with the care receiver monitoring device 101, information can be sent to the care giver terminal device 105 through the care managing device 104. Moreover, such a structure may be employed that information is sent to the care giver terminal device 105 when the care receiver monitoring device 101 communicates with the monitoring device reader 102 which is placed where the care receiver 201 does not usually pass through, such as an entrance.

By constructing the care receiver monitoring device 101 and the monitoring device reader 102 as described in the aforementioned examples, a care support system for the care receiver 201 and the care giver 202 can be provided on a person-by-person basis.

It is to be noted that this embodiment mode can be freely implemented in combination with the aforementioned embodiment mode.

### Embodiment Mode 3

In this embodiment mode, description is made on a different structure and mode of the care managing device 104 and the care giver terminal device 105 described in Embodiment Mode 1.

First, description is made on the care managing device 104 which carries out distributed processing. In recent years, integration of a computer technology and a network technology is progressing. By using a network in the information processing, a place to obtain information, a place to carry out the information processing, and a place where the information is stored are not required to be the same. By connecting devices having each function through a network, the distributed processing can be carried out. The distributed processing is an arithmetic processing carried out by distribution using a plurality of computers and processors. There are two major methods: to carry out the process using one computer which mounts a plurality of processors and to carry out the process using a plurality of computers which are connected through a network.

The distributed processing that the care managing device 104 of the invention carries out corresponds to the latter method to carry out the process using a plurality of computers which are connected through a network. This distributed processing, however, is not limited to an arithmetic processing. The distributed processing is realized by using through a network a plurality of devices each of which has a function to process detected information, a function to store care information, and a function to send and receive the information and which are not constructed together as one device, thereby the function as the care managing device 104 is achieved. The network here corresponds to a broad internet network including a closed network per company or region and a network which connects between associations.

Accordingly, a function as the care managing device 104 of the invention may be realized by several different devices connected though a network, which serve as an information processing unit 104a, a line communication unit 104b, a terminal communication unit 104c, and a care information storing unit 104d.

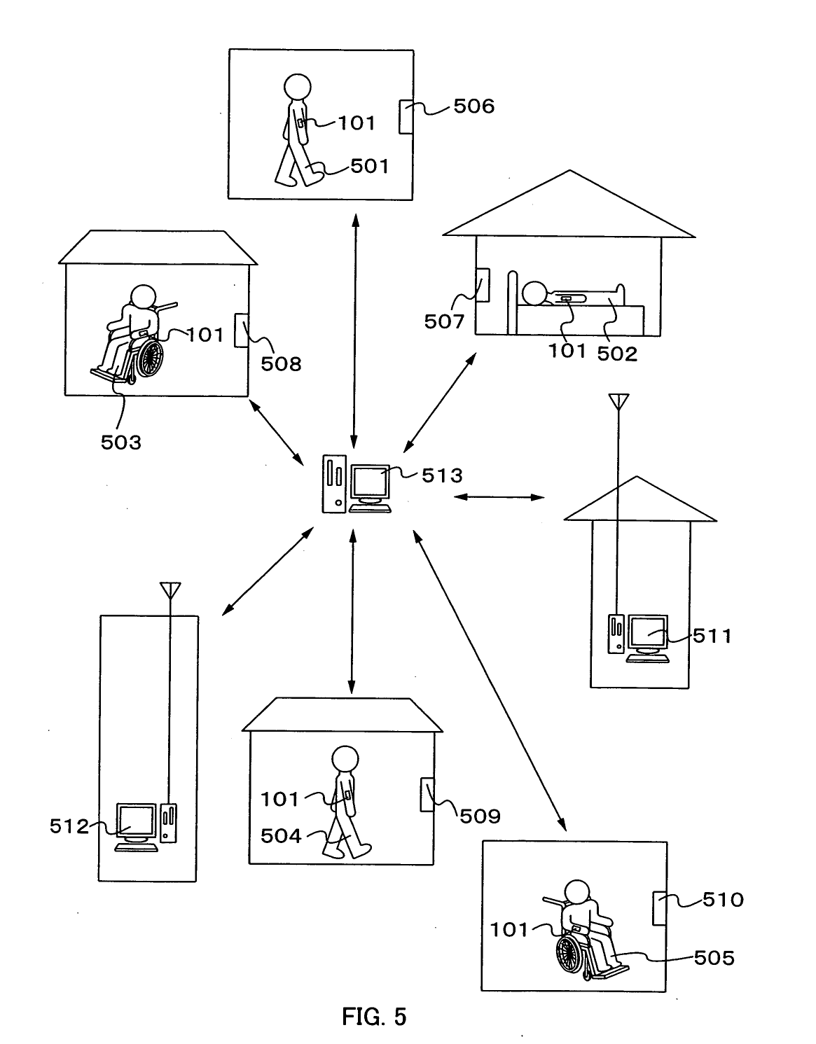

FIG. 5 shows a care support system including the care managing device 104 which carries out distributed processing. The care managing device 104 includes a computer 511 (512) and a database server (also simply referred to as a database) 513. The computer 511 (512) includes the information processing unit 104a, the line communication unit 104b, and the terminal communication unit 104c. The database server 513 includes the care information storing unit 104d and is connected to the computer 511 (512) through a network. The database server 513 databases and stores care information. Receiving the detected information, the care receiver specific information, and the reader specific information from the monitoring device reader 506 (507 to 510) through the database server 513, the computer 511 (512) accesses the database server 513 and carries out information processing.

With the aforementioned structure, a plurality of the computers 511 (512) may access the one database server 513 to carry out the information processing. In FIG. 5, for example, monitoring device readers 506, 507, and 508 placed in living areas of care receivers 501, 502, and 503 respectively send information to the computer 511. Monitoring device readers 509 and 510 placed in living areas of care receivers 504 and 505 respectively send information to the computer 512 through the database server 513. The computers 511 and 512 access the database server 513 to carry out the information processing.

In this manner, by the care managing device 104 carrying out distributed processing through a network, existing hardware resources can be efficiently used.

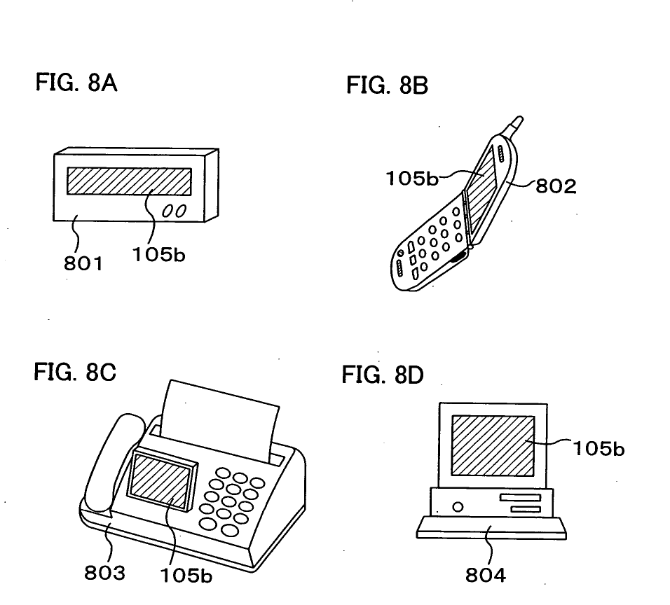

Next, description is made on the care giver terminal device 105 of the invention. FIGS. 8A to 8D show modes of the care giver terminal device 105. As shown in FIG. 8A, the care giver terminal device 105 can be manufactured as a dedicated care giver terminal device 801 including the communication unit 105a and the display unit 105b. Further, the care giver terminal device 105 can include the alarm unit 105c and/or the information requesting unit 105d.

As the care giver terminal device 105, an existing device including the communication unit 105a and the display unit 105b can also be used. As shown in FIG. 8B, an existing portable phone 802 can also be used. Further, as shown in FIG. 8C, the care giver terminal device 105 may also be a facsimile sending/receiving device 803. Furthermore, as shown in FIG. 8D, the care giver terminal device 105 may be a computer 804.

A mode of the care giver terminal device 105 is not limited to the aforementioned one. A care receiver and a care giver can use a care support system at low cost by using an existing device.

Next, description is made on the information requesting unit 105d included in the care giver terminal device 105. The care giver 202 who has the care giver terminal device 105 can request the current information such as the biological information and the life status of the care receiver by using the information requesting unit 105d. Accordingly, the information requesting unit 105d includes an input device, a signal generating circuit, and the like.

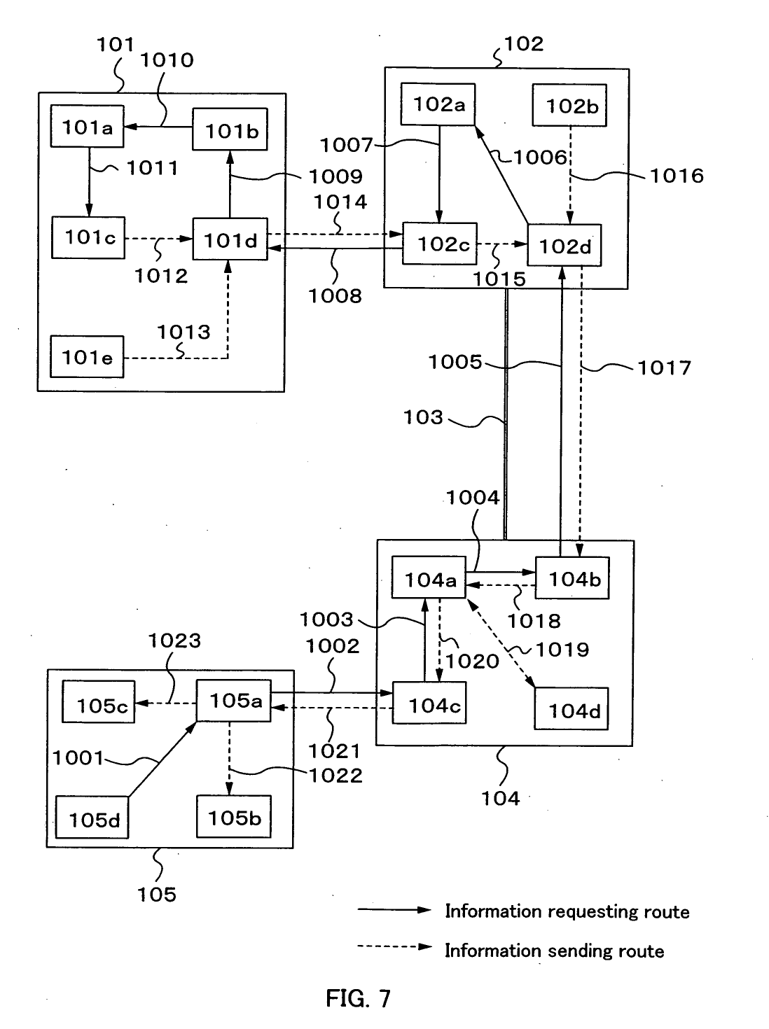

FIG. 7 shows an operation example of a care support system in the case of using the information requesting unit 105d. In FIG. 7, a sending route of an instruction to request information (hereinafter referred to as an information requesting route) is shown by a solid arrow and a sending route of the information (hereinafter referred to as an information sending route) is shown by a chain arrow. When the care giver 202 inputs data to the input device of the information requesting unit 105d, the information requesting unit 105d sends an information requesting instruction to the communication unit 105a (an arrow 1001) and then the communication unit 105a sends the information requesting instruction to the care managing device 104 (an arrow 1002).

Receiving an information requesting instruction from the care giver terminal device 105, the terminal communication unit 104c included in the care managing device 104 sends the information requesting instruction to the information processing unit 104a (an arrow 1003). The information processing unit 104a sends an information requesting instruction to the line communication unit 104b (an arrow 1004) and the line communication unit 104b sends an information requesting instruction to the monitoring device reader 102 (an arrow 1005).

Receiving the instruction from the care managing device 104, the line communication unit 102d included in the monitoring device reader 102 sends the instruction from the care managing device 104 to the wireless communication control unit 102a (an arrow 1006). The wireless communication control unit 102a sends an information requesting instruction to the wireless communication unit 102c (an arrow 1007) and the wireless communication unit 102c sends the information requesting instruction to the care receiver monitoring device 101 (an arrow 1008).

Receiving the information requesting instruction from the monitoring device reader 102, the wireless communication unit 101d included in the care receiver monitoring device 101 sends the information requesting instruction to the detection control unit 101b (an arrow 1009). The detection control unit 101b orders the biological information detecting unit 101a to detect biological information (an arrow 1010). The biological information detecting unit 101a detects biological information of the care receiver and the detected information storing unit 101c stores the detected information (an arrow 1011).

Next, the detected information storing unit 101c and the care receiver specific information storing unit 101e send the detected information and the care receiver specific information to the wireless communication unit 101d (chain arrows 1012 and 1013) and the wireless communication unit 101d sends the information to the monitoring device reader 102 (a chain arrow 1014).

Receiving the information from the care receiver monitoring device 101, the wireless communication unit 102c included in the monitoring device reader 102 sends the information from the care receiver monitoring device 101 to the line communication unit 102d (a chain arrow 1015). At the same time, the reader specific information storing unit 102b sends reader specific information to the line communication unit 102d (a chain arrow 1016) and the line communication unit 102d sends the information to the care managing device 104 (a chain arrow 1017).

Receiving the information from the monitoring device reader 102, the line communication unit 104b included in the care managing device 104 sends the information from the monitoring device reader 102 to the information processing unit 104a (a chain arrow 1018). The information processing unit 104a accesses the care information storing unit 104d and carries out information processing (a chain arrow 1019). The information processing unit 104a sends the processed information to the terminal communication unit 104c (a chain arrow 1020) and the terminal communication unit 104c sends the information to the care giver terminal device 105 (a chain arrow 1021).

Receiving the information from the care managing device 104, the communication unit 105a included in the care giver terminal device 105 sends the information from the care managing device 104to the display unit 105b (a chain arrow 1022). The information is also sent to the alarm unit 105c when provided (a chain arrow 1023). The display unit 105b displays the information and the alarm unit 105c beeps.

The operations of the information requesting unit 105d and the care support system are not limited to the aforementioned. However, when the care giver terminal device 105 includes the information requesting unit 105d and the care support system performs the aforementioned operation, the care giver 202 can know the life status of the care receiver 201 in real time.

It is to be noted that this embodiment mode can be freely implemented in combination with the aforementioned embodiment modes.

### Embodiment 1

In this embodiment, description is made on an example where a care receiver and a care giver live using the care support system of the invention.

As an example of a user of the care support system of the invention, description is made on the case of a family composed of a first person who is aged and senile and a second person who is injured and lives on a wheelchair. The family is composed of these two people only who live with a care service provided by the organization for care support. The second person who is a care receiver is also a care giver for the first person who is senile. Each of the first person and the second person puts on the care receiver monitoring device 101. A plurality of the monitoring device readers 102 provided in a house can communicate with the care receiver monitoring devices 101 in various places of the house.

The organization which provides the care support manages the care managing device 104. Each of the second person and a home attendant dispatched from the organization carries the care giver terminal device 105. Here, the care giver terminal device 105 can receive information such as biological information and a life status of each of the first person and the second person who put on the care receiver monitoring devices 101.

By using the care support system of the invention, the second person who is disabled can know information such as the biological information and the life status of the first person. For example, in the case where the first person is sleeping in a bedroom and the second person worries how the first person is, the second person can see the information displayed by the care giver terminal device 105 and stop worrying. Further, even when something happens to the first person, a quick measure can be taken by seeing the information displayed by the care giver terminal device 105.

In the case where the first person goes out of the house for day care or the like, there is no care receiver who puts on the care receiver monitoring device 101 in a communicable range of the monitoring device reader provided in the house. In that case, the care managing device 104 sends information to the care giver terminal device, telling that there is no care receivers in the communicable range of the monitoring device reader. In such a case, a communication cutting off unit is provided for the monitoring device reader provided at the entrance. The monitoring device reader 102 including the communication cutting off unit includes an input device and a communication cutting off signal generating circuit, and the like. The monitoring device reader 102 in the house cuts off the communication with the care receiver monitoring device 101 which the first person puts on when the care giver operates the input device when the first person goes out.

The monitoring device reader further includes a communication resuming unit for resuming communication between the monitoring device reader and the care receiver monitoring device which the first person puts on when the first person comes back home. The communication resuming unit may include an input device, a communication resuming signal generating circuit, and the like. However, the care giver or the care receiver is likely to forget to operate the input device for resuming the communication. Therefore, the monitoring device reader provided at the entrance may include a communication resuming unit which automatically resumes communication when it senses the care receiver monitoring device which the first person puts on entering the communicable range.

Next, description is made on the care managing device 104 managed by the organization which provides the care support system. A home attendant dispatched by the organization generally rings a bell of a house and then the second person who is in the house opens the door. However, there might be no response when the bell is rung. In such a case, the home attendant cannot enter the house without notice, therefore, he/she calls the organization which provides the care support and asks for the instructions of the manager.

If the home attendant has the care giver terminal device 105 in such a case, he/she can know the life statuses, biological information, and the like of the first person and the second person. For example, if the life statuses and biological information of the first person and the second person are normal and they seem to be in the bedroom, they are supposed to be sleeping, thereby actions suitable for the situations can be taken. If the second person who heard the bell falls down because he/she went to the door hastily and cannot move at all, that situation can be known by the care receiver terminal device 105 and emergency actions suitable for the situations can be taken.

Further, the home attendant visits home of the care receiver as a job. If the home attendant has the care receiver terminal device 105 which displays the life status, biological information, and the like of the care receiver 24 hours a day every day, private time of the home attendant may be interrupted. In such a case, it is preferable that the care receiver terminal device 105 is carried only at a specific time and returned at the other time. It is also possible to control the care managing device 104 or the care giver terminal device 105 so that the care giver terminal device 105 receives and displays information only at the home attendant's working hours.

By using the care receiver monitoring device, the monitoring device reader, the care managing device and, the care giver terminal device, the care managing system and the care managing method using these of the invention as described above, a care support suitable for each one of the care receiver and the care giver can be provided, thereby the load of care can be reduced.

It is to be noted that this embodiment can be freely implemented in combination with the aforementioned embodiment modes.

This application is based on Japanese Patent Application serial no. 2005-089223 filed in Japan Patent Office on 25, Mar., 2005, the entire contents of which are hereby incorporated by reference.

What is claimed is:

1. A monitoring device comprising:
a wireless communication unit for communicating with a care receiver monitoring device wirelessly through electromagnetic waves;
a control unit for controlling the wireless communication unit;
a storing unit for storing specific information of the monitoring device;
and
a line communication unit for communicating with a care managing device through a communication line.

2. A monitoring device according to claim 1,
wherein the control unit includes a counter and a control circuit;
wherein the storing unit includes a memory;
wherein the wireless communication unit includes a resonant circuit, a demodulation circuit, a modulation circuit, an encoding circuit, a decoding circuit, and an information determining circuit; and
wherein the line communication unit includes a communication control circuit and a memory control circuit.

3. A monitoring device comprising:
a reception reader and
a plurality of transmission readers,
wherein the reception reader comprises:
a wireless communication unit for controlling communication with a care receiver monitoring device wirelessly through electromagnetic waves;
a control unit for controlling the wireless communication unit; and
a first communication unit which communicates with the transmission readers wirelessly,
wherein each of the transmission reader comprises:
a storing unit for storing reader specific information;
a line communication unit for communicating with a care managing device through a communication line; and
a second communication unit which communicates with the reception reader wirelessly.

4. A monitoring device according to claim 3,
wherein the wireless communication control unit includes a counter and a control circuit;
wherein the storing unit includes a memory;
wherein the wireless communication unit includes a resonant circuit, a demodulation circuit, a modulation circuit, an encoding circuit, a decoding circuit, and an information determining circuit;
wherein the line communication unit includes a communication control circuit and a memory control circuit;
wherein each of the first communication unit and the second communication unit includes a resonant circuit, a demodulation circuit, a modulation circuit, an encoding circuit, a decoding circuit, an information determining circuit, and a power source device.

5. The monitoring device according to claim 1,
wherein a communication cutting off unit is provided for temporarily cutting off the wireless communication with the care receiver monitoring device.

6. The monitoring device according to claim 3,
wherein a communication cutting off unit is provided for temporarily cutting off the wireless communication with the care receiver monitoring device.

7. The monitoring device according to any one of claim 1,
wherein a communication cutting off unit is provided for temporarily cutting off the wireless communication with the care receiver monitoring device; and
wherein the communication cutting off unit includes an input device and a communication cutting off signal generating circuit.

8. The monitoring device according to any one of claim 3,
wherein a communication cutting off unit is provided for temporarily cutting off the wireless communication with the care receiver monitoring device; and
wherein the communication cutting off unit includes an input device and a communication cutting off signal generating circuit.

9. The monitoring device according to claim 1,
wherein a communication resuming unit is provided for resuming wireless communication with the care receiver monitoring device, which is cut off by the communication cutting off unit.

10. The monitoring device according to claim 3,
wherein a communication resuming unit is provided for resuming wireless communication with the care receiver monitoring device, which is cut off by the communication cutting off unit.

11. The monitoring device according to claim 1,
wherein a communication resuming unit is provided for resuming wireless communication with the care receiver monitoring device, which is cut off by the communication cutting off unit; and
wherein the communication resuming unit includes an input device and a communication resuming signal generating circuit.

12. The monitoring device according to claim 3,
wherein a communication resuming unit is provided for resuming wireless communication with the care receiver monitoring device, which is cut off by the communication cutting off unit; and
wherein the communication resuming unit includes an input device and a communication resuming signal generating circuit.

13. A care receiver monitoring device comprising:
a detecting unit for detecting biological information of a care receiver;
a detection control unit for controlling the detecting unit;
a first storing unit for storing detected information;
a wireless communication unit for communicating with a monitoring device reader wirelessly through electromagnetic waves; and
a second storing unit for storing care receiver specific information.

14. A care receiver monitoring device according to claim 13,
wherein the detecting unit includes a sensor for detecting the biological information;
wherein the detection control unit includes a power source device, a counter, a sensor control circuit, and a memory control circuit;
wherein the first storing unit includes a memory;
wherein the wireless communication unit includes a resonant circuit, a power source circuit, a demodulation circuit, a modulation circuit, an encoding circuit, a decoding circuit, an information detecting circuit, and a memory control circuit; and
wherein the second storing unit includes a memory.

15. The care receiver monitoring device according to claim 14,
wherein the power source device included in the detection control unit is a power generating device which generates power by light or a body temperature.

16. The care receiver monitoring device according to claim 14,
wherein the memory included in the first storing unit is a nonvolatile memory in which data can be rewritten.

17. The care receiver monitoring device according to claim 14,
wherein the memory included in the second storing unit is a write-once type nonvolatile memory.

18. The care receiver monitoring device according to claim 14,
wherein the sensor included in the detecting unit detects at least one of a body temperature, a heart rate, a blood pressure, a breath rate, a blood oxygen rate, a moving rate of a care receiver's body, and an acceleration rate of a care receiver's body.

19. The care receiver monitoring device according to claim 13,
wherein the care receiver specific information contains an identification number for identifying the care receiver.

20. A care managing device comprising:
an information processing unit for determining a life status of a care receiver based on detected information, care receiver specific information, reader specific information, and care information;
a line communication unit for communicating with a monitoring device reader through a communication line; and
a terminal communication unit for communicating with a care giver terminal device;
a care information storing unit for storing care information.

21. A care managing device according to claim 20,
wherein the information processing unit includes an SRAM, a central processing unit, and a memory control circuit;
wherein the line communication unit includes a communication control unit;
wherein the terminal communication unit includes a communication control circuit, a memory control circuit, an antenna, a demodulation circuit, and a modulation circuit; and
wherein the care information storing unit includes a hard disc.

22. A care managing device comprising:
a computer and a database connected through a network,
wherein the computer includes:
an information processing unit for determining a life status of a care receiver based on detected information, care receiver specific information, reader specific information, and care information;
a line communication unit for communicating with a monitoring device reader through a communication line; and
a terminal communication unit for communicating with a care giver terminal device,
wherein the database includes a storing unit for storing care information.

23. A care managing device according to claim 22,
wherein the database includes a storing unit for storing care information;
wherein the information processing unit includes an SRAM, a central processing unit, and a memory control circuit;
wherein the line communication unit includes a communication control circuit;
wherein the terminal communication unit includes a communication control circuit, a memory control circuit, an antenna, a demodulation circuit, and a modulation circuit; and
wherein the storing unit includes a hard disc.

24. The care managing device according to claim 20,
wherein the storing unit databases and stores care information related to a care support; and
wherein the storing unit reads out the care information corresponding to the care receiver specific information stored in the care receiver monitoring device.

25. The care managing device according to claim 20,
wherein the storing unit databases and stores care information related to a care support; and
wherein the storing unit reads out the care information corresponding to the care receiver specific information stored in the care receiver monitoring device.

26. The care managing device according to claim 22,
wherein the storing unit databases and stores care information related to a care support; and
wherein the storing unit reads out the care information corresponding to the care receiver specific information stored in the care receiver monitoring device.

27. A care giver terminal device comprising:
a communication unit for communicating with a care managing device; and
a display unit for displaying information of biological information and a life status of a care receiver.

28. A care giver terminal device according to claim 27,
wherein the communication unit includes a communication control circuit, an antenna, a demodulation circuit, and a modulation circuit; and
wherein the display unit includes a memory, a memory control circuit, and a display device.

29. The care giver terminal device according to claim 27,
wherein an alarm unit which beeps when receiving information is further provided.

30. The care giver terminal device according to claim 27,
wherein an alarm unit which beeps when receiving information is further provided; and
wherein the alarm unit includes a speaker.

31. The care giver terminal device according to claims 27,
wherein an information requesting unit for requesting a care managing device for information of a care receiver is further provided.

32. The care giver terminal device according to claim 27,
wherein an information requesting unit for requesting a care managing device for information of a care receiver is further provided; and
wherein the information requesting unit includes an input device and an instruction signal generating circuit.

33. A care support system comprising:
a care receiver monitoring device for detecting biological information of a care receiver and sends the detected information to a monitoring device reader;
a care managing device for determining a life status of a care receiver based on information received from the monitoring device reader and sends the determined information to a care giver terminal device; and
a care giver terminal device for displaying information received from the care managing device.

34. A care support method comprising:
detecting and sending biological information of a care receiver to a monitoring device reader by a care receiver monitoring device;
sending the information received from the care receiver monitoring device to a care managing device by the monitoring device reader;
determining a life status of a care receiver based on the information received from the monitoring device reader and sending the determined information to a care giver terminal device by the care managing device; and
displaying the information received from the care managing device by the care giver terminal device.

35. The care support system according to claim 34, further comprising:
sending an information requesting instruction to the care managing device by the care receiver terminal device;
receiving the instruction and sending an information requesting instruction to the monitoring device reader by the care managing device; and
receiving the instruction and sending an information requesting instruction to the care receiver monitoring device by the monitoring device reader.
